(19) United States
(12) Patent Application Publication
(10) Pub. No.: US 2026/0230478 A1
(43) Pub. Date: Aug. 6, 2026

(54) PERSONALIZATION PLATFORM FOR USER-SPECIFIC RECOMMENDATIONS USING ARTIFICIAL INTELLIGENCE MODEL SELECTIONS FROM USER PRIVACY CONTROLS

(71) Applicant: PAYPAL, INC., San Jose, CA (US)

(72) Inventors: Jacqueline Karlin, Austin, TX (US); Scott Hamilton, Aldie, VA (US); Ravi Shankar Chandrasekaran, Santa Clara, CA (US); Jonathan Russell Barksdale, Scottsdale, AZ (US); Nitin S. Sharma, San Francisco, CA (US)

(21) Appl. No.: 19/409,115

(22) Filed: Dec. 4, 2025

Related U.S. Application Data
(60) Provisional application No. 63/752,438, filed on Jan. 31, 2025.

(51) Int. Cl. H04L 9/40; G06Q 30/0601

(52) U.S. Cl. CPC H04L 63/102; G06Q 30/0631

(57) ABSTRACT

Computer and data processing improvements relating to artificial intelligence (AI) for near real-time (NRT) recommendation are disclosed. A service provider may utilize an AI system including different machine learning (ML) models and a privacy management platform that may manage user consents for profile or other user information usage for NRT recommendations. The AI system may interact with merchant platforms to monitor session data for sessions between computing devices of the user and the merchant platforms. The AI system may detect data from shopping experiences and/or behaviors to generate feature data for ML features of the ML models. The AI system may utilize the data with profile data, when authorized based on the user consents, to generate the NRT recommendations. Further, the AI system may store the data for use by an offline system to train and/or retrain ML models for more accurate decision-making.

### CROSS REFERENCE TO RELATED APPLICATION

The present application claims priority to U.S. Prov. Patent Application No. 63/752,438, filed January 31, 2025, which is incorporated by reference in its entirety.

### TECHNICAL FIELD

The present application generally relates to artificial intelligence (AI) and predictive recommendations by AI models, and more particularly to personalizing user-specific recommendations through AI model selection from granular privacy controls.

### BACKGROUND

Users may utilize various mobile computing devices, such as tablet computers, smart phones, and wearable computing devices, to perform computing operations and communications. Computing devices may be used to browse items, look up items for sale, complete purchases online and/or through retail storefronts and other real-world locations, and the like. Users may also utilize computing devices, for example, to perform electronic transaction processing with online transaction processors, which may also look to facilitate users’ experiences with shopping, purchasing, and the other merchant and sales interactions. As such, transaction processors and other services providers may utilize different processes and procedures to try to understand and determine their customers and other users’ interests, which may be used to recommend certain products, services, actions, discounts, benefits, and the like to users.

However, providing recommendations is typically based on user data, which may include private and privacy protected data, such as personally identifiable data (PII), know your customer (KYC) data, financial data, and the like that may be privacy protected and/or desirable to remain private or not be shared. Service providers may implement privacy protection systems and controls, and may be required to comply with laws, regulations, and company rules or objectives governing privacy protection. This may prevent data from being shared without consent. However, this may also adversely affect the accuracy of recommendations and degree of granularity to which those recommendations can be made. Thus, it is desirable to provide a system that can facilitate different degrees of granularity of predictive outputs based on privacy controls, for an improved digital platform for predictive services using allowed or restricted data access.

### BRIEF DESCRIPTION OF THE DRAWINGS

FIGS. 1A and 1B are block diagrams of networked systems suitable for implementing the processes described herein, according to an embodiment;

FIGS. 2A and 2B are exemplary system architectures for personalized user recommendations through intelligent AI model selections based on privacy controls, according to an embodiment;

FIG. 3A and 3B are exemplary environments showing interactions between system components of a service provider when providing personalized recommendations from intelligent AI model selection, according to an embodiment;

FIGS. 4A and 4B are exemplary diagrams of AI models and AI personalization for user-specific recommendations using a personalization platform, according to an embodiment;

FIG. 5 is a flowchart for a personalization platform for user-specific recommendations using AI model selection from user privacy controls, according to an embodiment; and

FIG. 6 is a block diagram of a computer system suitable for implementing one or more components in FIGS. 1A and 1B, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a personalization platform for user-specific recommendations using AI model selection from user privacy controls. Systems suitable for practicing methods of the present disclosure are also provided.

A service provider, such as an online transaction processor, may detect that a user is engaging or has engaged with a merchant or other online shopping platform and/or experience, such as browsing products, services, or other items for sale or executing searching for those items. Once the user has been identified and verified, the service provider may determine whether the user has authorized access to a profile that may include the user’s preferences, interests, past historical information or activity, financial or personal information, and the like. For example, the profile may include PII and KYC data, financial information, tracked and historical information, and the like. The authorization may be associated with a preference, opt-in or opt-out, or the like that is associated with a personalization platform and personalized recommendations and/or advertisements that may be provided to the user. For example, the user may elect to receive recommendations for products, services, or other items when browsing merchants and marketplaces, or the user may prefer to have personalization for their recommendations, browsing sessions, and the like based on their user profile. However, the user may also not elect to have such recommendations made, or may not want to share profile information and/or use the profile information for personalization, which may require adherence to data privacy obligations and requirements.

Based on the accessibility to the user’s profile and information contained in the user’s profile, the service provider may select an AI model for one or more recommendations. In some embodiments, this may be a generic recommendation model for general users, such as a common or unknown user without knowledge of the user and/or user’s information, preferences, history, and the like. However, if access to the profile has been authorized and permitted, the granularity to the model features, such as machine learning (ML) model or neural network (NN) features may be more user-specific and may allow for more user-specific and personalized recommendations. As such, a product, service, action, or other item may be recommended to a user from an inference or other output, and the user’s behavior events with that recommendation and/or during the shopping experience may be tracked. Such events may be converted to features in a local environment, cache, or cloud computing system, and may be stored as near-real time (NRT) features for further use with model training, additional recommendations and inferencing for the user, and the like.

In order for users to utilize these services and recommendations of a personalization platform, an online service provider (e.g., an online transaction processor, such as PAYPAL®) typically has to onboard the users and/or provide account services to the users of the online service provider for account establishment. Such services discussed herein may also be provided to other entities, such as groups of users, businesses, merchants and their employees or other individual users, etc. A user wishing to establish the account may first access the online service provider and request establishment of an account. An account and/or corresponding authentication information with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information.

The user may also be required to provide financial information, including payment card (e.g., credit/debit card) information, bank account information, gift card information, benefits/incentives, and/or other funding sources. This information may be used to process transactions for items and/or services including purchases associated with browsed and/or recommended items and other content from the personalization platform. In some embodiments, the account creation may establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and other transaction processing services. However, other service providers may also provide all or part of the computing services and resources discussed herein for a personalization platform, AI model training and/or inferencing, NRT feature storage and other data storage or management, and the like. Data obtained during the onboarding and afterwards may then be used to provide more personalized recommendations to the user.

Once the account of a user is established with the service provider, the user may utilize the account via one or more computing devices, such as a personal computer, tablet computer, mobile smart phone, or the like. The user may engage in one or more online or virtual interactions that may be associated with electronic transaction processing, including browsing and purchasing items, engaging in online digital shopping experiences, transferring funds between users and/or providing users with funds for purchases, and the like. Other online interactions may be associated with images, music, media content and/or streaming, video games, documents, social networking, media data sharing, microblogging, and the like. The user may utilize a computing device to access an online platform of a merchant or merchant marketplace, including one provided the service provider or another. As such, the user may engage in a shopping experience with a merchant by browsing items for sale, where personalized recommendations may be provided during this or a subsequent shopping experience.

Initially, the service provider may identify the user when engaging with the merchant. The service provider may utilize a customer and/or visitor identity platform by which users may be identified on merchant or other entity websites and/or in corresponding applications. Identity signals of the user may be captured of the user, such as a device fingerprint, email or other identifier, phone number, account information or linking, application installation, or other signals from the user’s device and/or that may be provided by the user when interacting with the merchant’s website, application, or other platform. The service provider may then calculate an identity score using an ML model or other AI model and/or AI system component for user identification inferencing and predicting. The score may be associated with how closely the user’s information and/or behaviors are likely to match a known user and/or profile for a user that may be stored and/or accessible to the service provider. As such, the user and/or the user’s profile and other information may be identifiable and retrievable by the service provider to provide information for making a more appropriate user recommendation.

The service provider may then determine an authorization that the user has provided for access to the profile and/or personalization of recommendations and other information to be provided to the user based on the profile. In this regard, a data allowance and access management platform may be provided to act as a control point for data externalization and use by other platforms, applications, and systems. This management platform may consolidate and configure rules for consent and choices (e.g., opt-in and/or opt-outs) for data privacy, security, and usage, and well as a policy rules manager for policies related to data privacy including permissions for data access and/or usage. An ML model, rules engine, or other AI system may then determine an authorization for access to the user’s profile, and, if permitted, may then provide access to the user’s profile data including any preferences, settings, historical information, activities, inferred or learned information, and the like.

If access is permitted, the user’s profile and/or information about the user may be provided to the merchant’s website and/or platform or may be used by the service provider to personalize recommendations and other information to the user on the merchant’s website. The user may be greeted when visiting the merchant’s website or provided other information, alerts, notifications, and the like that may provide the user with a contextual understating that the user’s profile is on the merchant’s website, has been shared with the merchant’s website, or has been used to provide product recommendations on the merchant’s website, as permitted by the user’s privacy settings and authorizations. In some embodiments, the personalization may occur at another time, such as when the user adds a product to a digital shopping cart or when the user executes a search for an item, and other activities, behavior, or events. For example, the outputs from the application programming interfaces (APIs) for the personalization platform may provide a scenario, notification, or customization of personalized product recommendations using the user profile for the user and the merchant website so that the user is provided contextual understanding that the user is being recommended products by the service provider and/or based on their selection of personalization and/or product recommendations. Consumers of the merchants that opt in to personalization using the platform described herein would understand, from the context or scenario provided by the personalization platform on the merchant website, why their profile, information, and/or product recommendations are on and/or available with the merchant’s website or other platform. This may include identification and/or disclosure of any privacy settings or preferences for enabling and/or disabling the personalization and/or sharing of data with the merchant’s website specifically, or generally for use with the personalization platform and/or product recommendations.

If no access is determined, the personalization platform for recommendations to the user may proceed with a general or unknown user flow by which general recommendations are provided based on the user’s determined location and/or shopping experience (e.g., current activities, shopping cart, browsing actions or navigations, searches, etc.) and other publicly available data. As such, the user may not be directly identified with the merchant and information may not be provided to the merchant’s website and/or platform for user personalization. Since no information is shared with the merchant and/or used with the personalization engine and platform for product recommendation, the user would recognize that they are proceeding as an anonymous or guest user, or is proceeding to browse and/or add items to a digital cart without a user login and history. Instead, generalized information about the user, the browsing session with the merchant and/or search of the merchant’s website, and/or behaviors and events while browsing may be used. In some embodiments, this may include a location of the user.

The location may be determined or inferred from the user’s IP address or other location information, such as a geolocation, provided during the session between the user and the merchant, such as the digital communication and browsing session between the user’s device and the merchant or merchant marketplace’s servers, cloud infrastructure, applications/websites, etc. As such, the personalization platform may utilize a generic user ML model, such as one that relies on ML features associated with the aforementioned data. However, if a profile is accessible and the profile data is allowed to be retrieved for the user, the profile data may be used to provide more granular detail to the user, and therefore the recommendations.

The profile (or profile data) may include additional information about the user, the user’s history or past activities, purchases, browsing sessions, etc., and/or the user’s financial information. All of this data may be utilized to provide more user-specific and tailored recommendations and other information. However, the user profile, account and/or profile system, and/or data management system may also all provide granular controls for the data that the user may provide and/or allow tracking of for profile addition and/or entry. For example, the user may elect to provide and/or opt-in to sharing of personal or demographic information including age, location, employment, relationship status, etc. The user may otherwise opt-out or elect not to track a browsing history, past searches, etc. Each of these granular privacy controls may establish what data is stored by, with, and/or in the user’s profile, and therefore when the profile data is used for user-specific recommendations and other communications, the degree of specificity and personalization of the communications may also be controlled by the user.

As such, the personalization platform may analyze the profile data to determine ML model features available in such data, and extract or determine feature data for those ML features from the profile data. The personalization platform may then utilize an ML model selector with multiple different available ML models to generate a recommendation. A plurality of different ML models may be used by the platform for different recommendations and specificity of those recommendations, which may be controlled by the granularity to the user’s profile data provided. As such, depending on the available profile data for the user, and therefore the ML model features that may be used for recommendation generation, an ML model may be selected and feature data for those ML features may be determined, extracted, and/or converted from the profile data. In addition to that feature data, additional ML features of the ML models may exist for the user’s current shopping session, context, and/or experience. For example, the ML features may be associated with the user’s location, current items of interest or that have been browsed/searched, the merchant, brands identified or searched, etc. Feature data for those ML features may also be extracted from the user’s current session’s data and/or context.

The personalization platform may generate a recommendation to the user using the ML model, such as by inferring an interest or score associated with a likelihood that the user may be interested in another product or service, another merchant, or the like. The recommendation may correspond to an ML output based on feature data for the ML features of the selected model. The recommendation may be user-specific based on the known or available information for the user (e.g., location, profile data, etc.), as well as the session and shopping context. Thereafter, the recommendation may be output to the user, for example, through a pop-up, window, part of a webpage or UI, or other notification that may be presented to the user during the session or sent as a communication to the user. The user may then interact with the recommendation or perform other activities during the session. These activities may correspond to behavior events of the user during the session, which may be monitored and tracked by the service provider. The recommendation to the user, the ML feature data and/or transformed data for the ML features, and/or the behavior events of the user may all be tracked and cached or otherwise stored locally and/or in storage for the service provider’s personalization platform’s AI system that may be more quickly accessed than other storage systems, such as deep storage, remote database storages, etc. This allows for quick retrieval for further recommendations and other actionable steps, which enables more real-time recommendations to be provided to the user and increases likelihood of engagement with the recommendation.

When the behavior events are detected, the personalization platform and/or an NRT processor system and storage may process the behavior events for NRT features associated with and/or utilized by the ML model(s) for inferencing. For example, NRT features may correspond to those features having dynamic or varying values, for example, those values that may change on a short-term basis or over a time period/interval. These behavior events may be captured from different data streams and/or data queues associated with the user’s device, the merchant’s platform and system, and other applications, websites, and the like that may interface with the service provider’s personalization platform through one or more APIs and calls to or exchanged between such APIs and services. The personalization platform may deduplicate such events to prevent the same event from being stored and/or considered multiple times and may be converted to NRT features through a feature and data extraction process associated with those ML features.

The NRT features may then be stored in the local or quick access memory and/or storage component (which may include a computing environment or storage for such a computing environment for the personalization platform, such as a cloud computing environment and cloud storage system). The personalization platform may utilize the NRT features in an online environment to continue to make recommendations to the user, for example, in response to detection of another behavior event or one or more behavior events that specifically trigger the personalization platform to make another recommendation (e.g., a new search for an item, a navigation on a website or to a new website/merchant, browsing a different item or category, etc.). As such, the recommendations may be changed and updated based on changing NRT features, and the NRT features may be appropriately weighted to provide additional weight in the recommendation to the recency of the behavior events.

Additionally, the NRT features may be utilized in an offline computing environment for offline ML model training and/or retraining or reinforcement learning. For example, one or more additional ML models, or the trained ML models, may be trained, retrained, or otherwise configured in an offline environment where the ML algorithm and training technique may be used to train the nodes, layers, clusters, neurons/synapsis, and the like of the corresponding ML model, NN or other deep learning model, or other AI model and/or system for inferencing. The NRT features may be used as training data during model training, where, once the model has been trained, tested, and otherwise validated, the model may then be brought back to the live production computing environment for real-time decision-making and inferencing, such as predicting recommendations to make to a user, as discussed herein.

As such, the service provider may detect and/or determine interactions by users with merchants, such as when a user engages with a merchant and/or merchant’s digital platform through a user behavior event, activity, action, or the like. The service provider may utilize a coordinated system of devices, servers, digital platforms, and the like to provide detection of user-merchant sessions, and correspondingly identify users for personalized recommendations or actions. An AI system may be utilized by the service provider to provide more accurate and specific recommendations and other communications to the user in a faster and more efficient manner, bypassing the need for individual review and outreach and provide a user-specific experience through a personalization platform. Further, the personalization platform may maintain, review and enforce privacy and consent preferences, thereby only using data when authorized and maintaining compliance with legal requirements for data security, privacy, and consent. Thus, the service provider may provide an improved data privacy system that enforces such requirements while maintaining a high degree of personalization for more accurate automated communications.

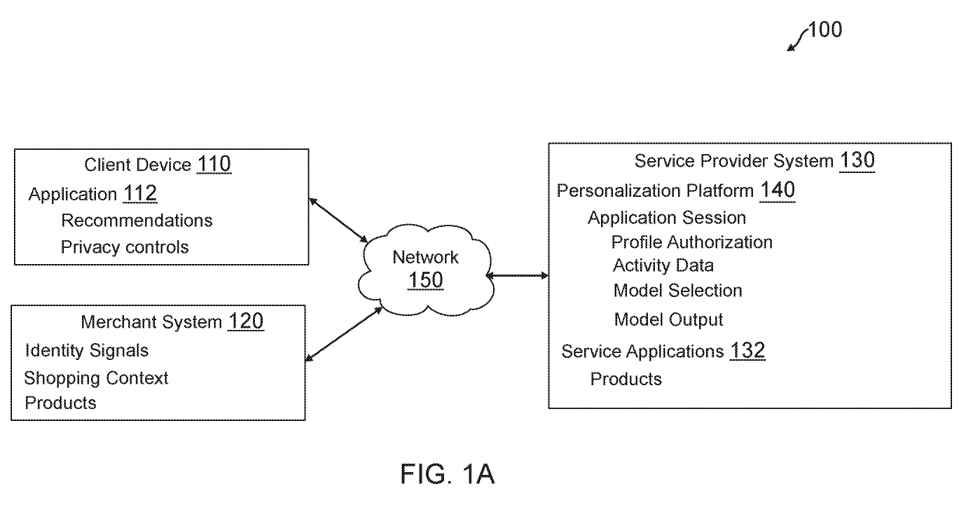

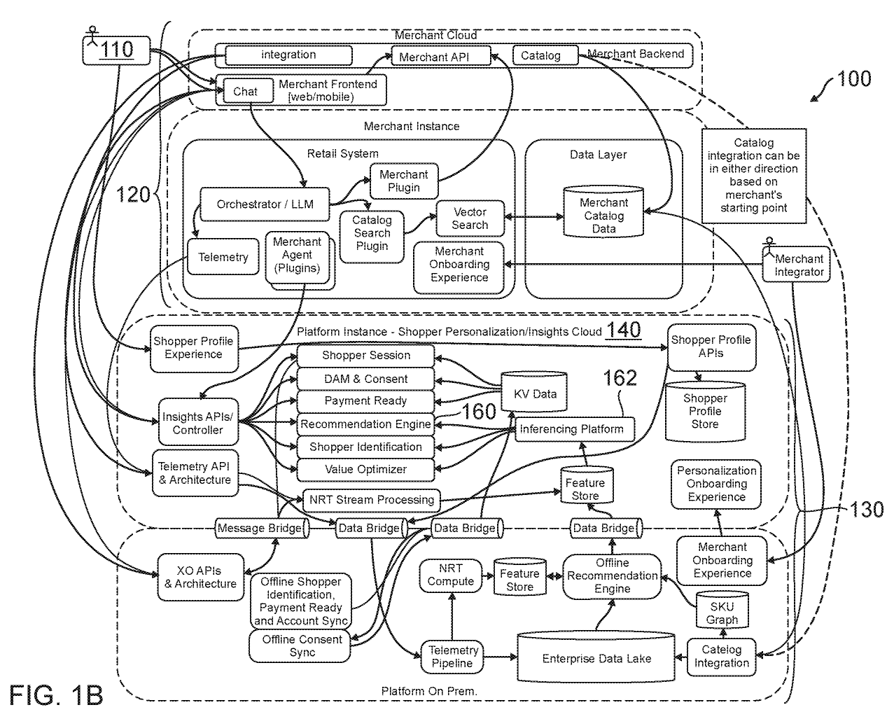

FIGS. 1A and 1B are block diagrams of networked systems suitable for implementing the processes described herein, according to an embodiment. In FIG. 1A, a system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIGS. 1A and 1B may be deployed in other ways, and that the operations performed, and/or the services provided by such devices and/or servers, may be combined or separated for a given embodiment and may be performed by a greater number or fewer number of devices and/or servers. One or more devices and/or servers may be operated and/or maintained by the same or different entities.

System 100 in FIG. 1A includes a client device 110, a merchant system 120, and a service provider system 130 in communication over a network 150. Client device 110 may be used to establish an account with service provider system 130 and/or another service provider, which may be used for electronic transaction processing of items and creation/maintenance of a profile of a user for personalization of services, product recommendations, and the like. Service provider system 130 may detect a session between client device 110 and a website, application, or other digital platform for a merchant associated with merchant system 120, such as based on communication and data exchange sessions between client device 110 and merchant system 120. In this regard, the session may be used to personalize content for the user associated with client device 110 by service provider system 130 through determining a privacy authorization of the user to access a profile usable for AI model selection and inferencing of product (which includes services, data access, and other offerings by merchant system 120) recommendations and other personalized communications. Service provider system 130 may receive signals and other information from merchant system 120 for the session and may select an AI model and perform recommendation personalization for a user using client device 110. Thereafter, behavior events of the user may be tracked and used by service provider system 130 to update such ML models, as well as provide real-time updates and/or additional recommendations using NRT features and the like.

Client device 110, merchant system 120, and service provider system 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Client device 110 may include an application 112, which may be used to access a website or UI to perform actions or operations. In various embodiments, application 112 may correspond to a general browser application or a more specific and dedicated application of a merchant, service provider, and the like. As such, application 112 may be used to engage in electronic transaction processing by accessing a website or application data for products for sale from a merchant corresponding to merchant system 120. Merchant system 120 may include one or more applications, components, and/or connected devices/servers that may be configured to connect, join, or create the session with client device 110 for the user’s shopping experience in order to provide information to client device 110 for the user’s browsing and/or purchasing. This may include information for products of interest to the user, as well as those that may be recommended to the user.

Merchant system 120 may detect and/or determine and track identity signals associated with client device 110, which may be provided to service provider system 130 through one or more integrations with computing services, APIs and the like of a product recommendation platform for service provider system 130. Service provider system 130 may be maintained, for example, by an online service provider, which may provide operations for product recommendation through AI models and systems, as well as electronic transaction processing. Various embodiments of the processes described herein may be provided by service provider system 130 and may be accessible by client device 110 when interacting with merchant system 120. Service provider system 130 includes one or more processing applications which may be configured to interact with client device 110, merchant system 120, and/or other devices and servers for personalizing recommendations, as well as performing electronic transaction processing, as described herein. In one example, service provider system 130 may be provided by PAYPAL®, Inc. of San Jose, CA, USA. However, in other embodiments, service provider system 130 may be maintained by or include another type of service provider.

When identity signals for client device 110 are received by service provider system 130, a personalization platform 140 may be used to identify the user and determine whether an authorization to access a profile has been granted. For example, for different application sessions, a profile authorization may be determined once the user has been identified, which may correspond to a binary “yes” or “no” (e.g., 1 or 0 in binary) as to whether personalization platform 140 is authorized to access the profile of the user. If no access is permitted, a general user recommendation AI model may be selected and utilized for product recommendations. However, those recommendations may be more user-specific if a profile is authorized to be accessed and profile data allowed to be retrieved. Additionally, activity data may be determined, which may be based on the session and shopping context or other information from the session. For example, with a session between client device 110 and merchant system 120, the user may view and interact with or based on the recommendation, may navigate to a new website of a new merchant or another webpage on the website of the merchant for a new item, brand, or product, purchase an item or add an item to a digital shopping cart indicating an intent to purchase, and the like. Other behaviors may be associated with abandonment of the session or shopping experience (e.g., closing a mobile application and/or locking the corresponding mobile device, a significant period of time without further activity or signals, etc.), which may also be used to determine user behaviors and interests associated with the recommended product, merchant, or the like.

Based on the profile data, or generic location, time, and/or merchant data when there is a lack of profile data or if no authorization permitted, and the activity data for the session, an ML model, NN, rule-based engine, or other AI model may be selected for product recommendations to the user. The selected model may be based on the model features that can be extracted and/or determined from the available data for the session, user/profile, and the like. After selection, the model may be used for model inferences and/or predictions, such as by scoring or determining a likelihood of interest in one or more products from merchant system 120. A model output may correspond to a score or other indicator that may be used to determine a recommendation of a product that a user may be interested in purchasing or browsing. Client device 110 may receive recommendations of the products and may further interact with the recommendations and/or merchant to provide additional behavior events and activities that are tracked. Such tracked behaviors may be used for NRT feature determination, further recommendations, and/or model training. Additionally, the user may access privacy controls to enable or permit access to the user’s profile in different situations including the current context for personalized recommendations and other user personalization. More granular controls regarding the data in the user’s profile may be established and controlled with that user’s profile, such as by opting in or opting out to data collection, monitoring, and/or tracking for use and/or storage with the user’s profile, including with specific types of user data and for specific uses or merchants.

Service applications 132 may correspond to one or more applications of service provider system 130 that provide computing services to users, such as transaction processing services, where recommendation can be provided through personalization platform 140 or service applications 132. Service applications 132 may be used to process payments and other services to one or more users, merchants, and/or other entities for transactions. In this regard, service applications 132 may be used by a user to establish a payment account and/or digital wallet, which may be used to generate and provide user data for the user, as well as process transactions. In various embodiments, financial information may be stored to the account, such as account/card numbers and information. A digital token for the account/wallet may be used to send and process payments, for example, through an interface provided by service provider system 130. In some embodiments, the financial information may also be used to establish a payment account and provide payments through the payment account. The payment account may be accessed and/or used through a browser application and/or dedicated payment application. Service applications 132 may be used to process a transaction, such as using an application/website or at a physical merchant location, for an item that was browsed and/or presented in a recommendation. Service applications 132 may process the payment and may provide a transaction history for transaction authorization, approval, or denial.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

In FIG. 1B, the components of system 100 are shown in further detail including their sub-components, architecture, data exchanges and calls, interactions, and similar hardware and software components. For example, in FIG. 1B, client device 110 may be used by a shopper or other user to interact with merchant system 120 when browsing or shopping for items, services, and other products that the merchant may sell. Merchant system 120 may be provided by and/or through a cloud computing provider in a cloud computing environment, as well as through other types of service providers including a merchant marketplace provider, a web hosting service provider, and the like. With a cloud computing environment, a merchant cloud may correspond to a cloud computing application and/or computing system provided in a cloud computing environment and utilized by the merchant to host one or more merchant applications that may be used for the offer and sale of products. Such merchant applications may utilize integrations with payment providers and other online transaction processors for electronic transaction processing and payments, such as service provider system 130, through a merchant backend. A merchant frontend may provide the accessible platform, interfaces, and portal by which client device 110 and corresponding shopper may interact with the merchant.

A merchant virtual machine (VM) instance may provide a VM and corresponding instance of an application or other code execution to enable the user to interact with the software system of the merchant for browsing and/or purchasing of items. Such a VM may also enable execution of the processes and integrations with service provider system 130, for example, to avail the merchant’s system of the shopper personalization services discussed herein, as well as additional computing services including payment and transaction processing. The merchant VM instance may be connected with and/or in communication with one or more of the components of service provider system 130 for detection of sessions between the shopper corresponding to client device 110 and the merchant corresponding to merchant system 120. A data layer may include merchant catalog data for a catalog of the merchant’s products, which may be accessed by service provider system 130 when making recommendations for products during a shopper personalization, as discussed herein.

Service provider system 130 may interact with one or more applications executing in the merchant VM instance for merchant system 120, which may be facilitated using a merchant integrator. The merchant integrator may correspond to a component, such as a software application and/or API, by which merchant system 120 and service provider system 130 may exchange data including API calls that may be communicated using an integration of merchant system 120 with a personalization platform for a shopping experience of users with the merchant. In some embodiments, service provider system 130 may detect a creation of a network or communication session from network traffic or may detect the session based on other data associated with client device 110 and merchant system 120. In other embodiments, a session for a digital shopping experience between the user and the merchant may be detected as being initiated and/or utilized for a shopping experience of the user, which may trigger a process for shopper personalization.

To provide shopper personalization, service provider system 130 may utilize a service provider VM instance to host an instance of one or more applications, platforms, and the like for shopper personalization and other shopper insights that may be determined, inferred, or predicted using one or more AI models. In this regard, the service provider VM instance may be used to provide personalization platform 140 in a cloud environment, and may provide a suite of applications, functions, and other components of personalization platform 140 for personalization of user experiences with the merchant and/or recommendations of products or services to the user that are available from the merchant. For example, a shopper profile experience may enable service provider system 130 to provide personalization to shoppers based on their profile and the current session between the user and the merchant, such as the current activities, behaviors, and/or inputs provided by the user when interacting with the merchant via their digital platform for shopping, browsing, and/or purchasing.

The shopper profile experience may utilize shopper profile APIs to communicate with a shopper profile store. Additionally, an insights API and controller may be utilized to provide an interface between merchant system 120 and service provider system 130 for personalization platform 140, which may include applications, processes, and/or components for shopper session detection and/or monitoring, a data allowance manager (DAM) and consent, payment readiness and/or payment processing availability, a recommendation engine, a shopper identification, and a value optimizer. As such, an API call, request, or the like to the insights API may be routed to personalization platform 140 for handling and personalization of one or more recommendations or other information and services provided to the corresponding shopper of the merchant. In addition to data for the session being used by personalization platform 140 with the shopper’s profile information from the shopper profile experience, a telemetry API may be used to monitor and/or track user behaviors during a session, which may correspond to NRT data and NRT features for AI models. As such, NRT stream processing may provide a component and/or processor to convert behavior events and other NRT data to NRT features for use in the online environment provided by the service provider VM instance for the personalization platform, but also an offline environment where model training and retraining may occur.

With personalization platform 140, once a session has been detected and/or identified by the components of personalization platform 140, the DAM and consent may be used to determine whether a shopper’s profile may be accessed and the profile data used for product recommendations and/or other personalization. In this regard, a consent determination may be made by an AI model, which may be based on consent and/or privacy opt-in, opt-outs, and other elections or preferences of the user, as well as privacy, consent, and data management policies and procedures. The authorization by the DAM and consent may correspond to a binary “Yes” or “No” that indicates whether a profile of the user may be accessed, and therefore whether a recommendation engine 160 may retrieve and use the profile data. For more granular control over the data tracked and/or used for the user’s profile, the user may utilize more granular privacy controls that opt-in, opt-out, or otherwise elect whether the user would like to input, or the service provider is authorized to track and/or store, user data for the user in and/or with the user’s profile. Such data used and/or stored for the profile data may include personal data, financial data, historical data and/or activities, and the like.

A recommendation engine 160 may utilize ML or other AI feature data extracted from the session’s data and, if available, the profile data of the user’s profile. Recommendation engine 160 may correspond to an AI system and platform for AI processing of data and outputs, such as an ML engine that may rely on ML models to generate and/or perform recommendations for users. In this regard, recommendation engine 160 may be connected to an inferencing platform 162, which may provide AI inferencing for different AI requirements of service provider server 130, such as risk, underwriting, advertisement, and the recommendations discussed herein. Inferencing platform 162 may provide a platform to the computing services, as well as merchants that utilize such services, that may utilize recommendation engine 160. If the profile data is not available, the session data may be used alone and, as such, an AI model may be selected for customer personalization that does not use features associated with the profile data, such as a “general user” or unknown, standard, or faceless user that does not have specific user traits, characteristics, preferences, and/or behaviors that normally may influence a recommendation or other personalization. For example, the recommendation may be based on a location of client device 110 and/or provided by the user or merchant during the shopping experience, as well as any additional data for the shopping experience and/or behaviors. However, if the profile data is authorized for access and retrieved, then a more specific AI model may provide improved, more accurate, and/or more personalized recommendations or other outputs for shopper personalization. Thus, an AI model may be required to be selected from multiple available models by recommendation engine 160 based on the features that can be used and/or the feature data available or extractable.

When selecting a model, a feature extractor or other processor may extract and/or compute data for the models’ features, and therefore determine which features have data available for processing. This allows for selection of an AI model that matches the corresponding granularity of user data available and/or permitted for access and use for shopper personalization (or other recommendation and/or data usage opt-in/opt-out or consent). The AI model may then provide an output based on the model’s training and the feature data for the session and/or profile provided as input, whether generalized or user-specific data. The AI model’s output may depend on the features and feature data, as well as the task or job of the AI model. For example, the recommendation system may have multiple different models for different purposes, as well as multiple iterations or versions of a model depending on the user data granularity or permission for use. These models may include one or more of a conversion prediction model, a next best action model, a trending/most popular recommendations model, a merchant/merchandise propensity model, an industry specific recommendation model, a cluster-based insights model, a geo-based trends model, an identity scoring model, a general product or information recommendation (i.e., a non-user-specific, such as recommendation that does not consider or rely on, or is not based on, a profile for a user) model, an LLM or other generative AI with language capabilities, a product-specific recommendation model, an SKU quality and/or scoring model, a catalog normalization model, a product summarization model, a speech-to-text model, and/or payment recognition or product purchase identification model.

Once the recommendation or other personalization has been determined based on the selected AI model’s output, personalization platform 140 may provide the personalization information and/or data to merchant system 120 for output to the user during the shopping experience of the user on the merchant’s platform. In addition to personalizing the shopping experience of the user using the received data, merchant system 120 and/or service provider system 130 may monitor and/or track any user behavior events and other activities during the shopping session, which may be provided to NRT stream processing and used to determine the NRT features that may be used for further AI model inferencing and/or shopper personalization. Additionally, the NRT features from the NRT stream processing may be used in the online environment, for example, to provide more particular, nuanced, specific, or recency-biased recommendations and other personalization. The NRT features may also be provided to and/or used in an offline environment for additional purposes after precomputation, determination, and/or storage in the online environment of the VM instance running personalization platform 140.

A data bridge may provide a bridge or connection between the online environment for the personalization platform in the service provider VM instance and an offline environment where offline jobs, data processing, and other tasks may be performed and completed. In the offline environment, precomputed features for ML model features may be utilized to train or retrain one or more ML models for shopper personalization and/or other insights, actions, or assistance that may be provided to shoppers during their shopping experience for a more personalized and efficient presentation of data, user interfaces and processing flows. As such, AI models may be made more accurate and efficient over time by monitoring and learning from the behaviors of shoppers with the recommendations and other personalization provided to the shopper by personalization platform 140.

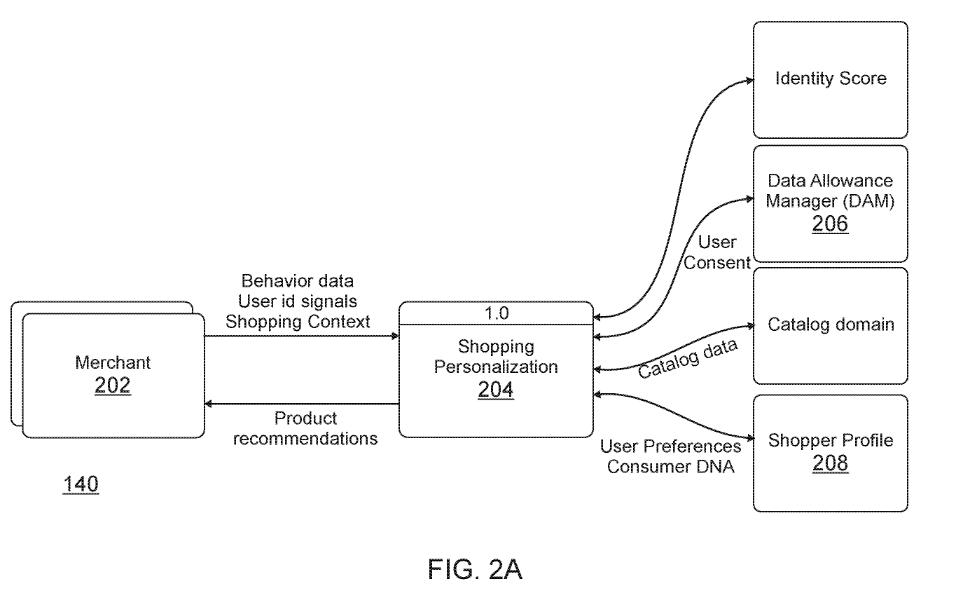

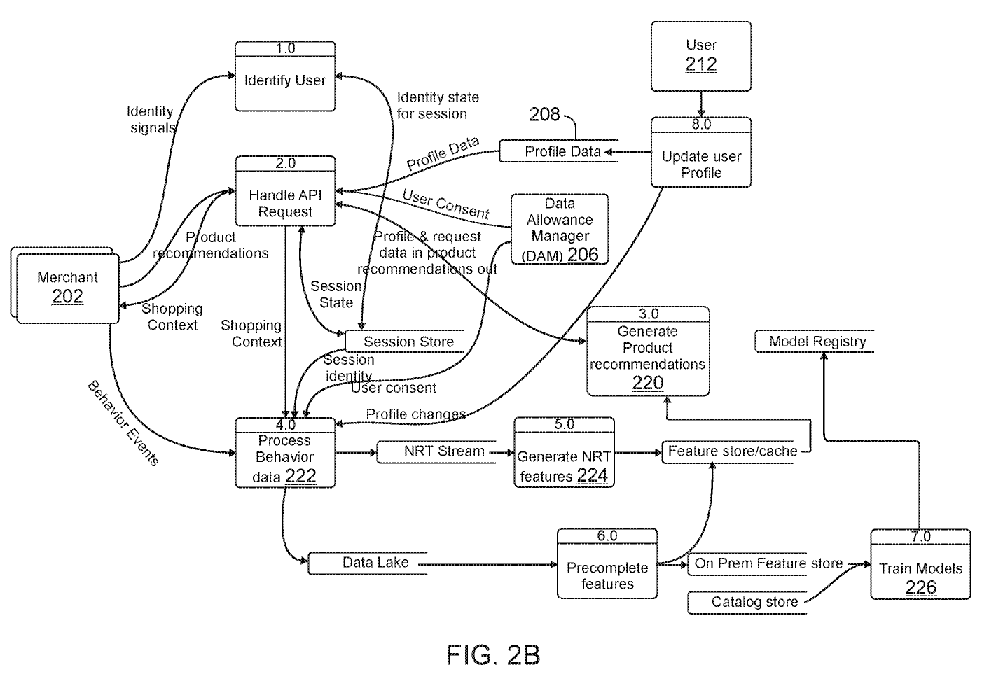

FIGS. 2A and 2B are exemplary system architectures for personalized user recommendations through intelligent AI model selections based on privacy controls, according to an embodiment. FIG. 2A shows a system architecture of personalization platform 140 where a merchant 202 may interact with a shopping personalization platform 204 of a service provider to provide a personalized shopping experience to each of the users that access a digital platform of merchant 202 for shopping and other user experiences. Merchant 202 may have been onboarded with shopping personalization platform 204 of the service provider and may be integrated with the service provider’s computing systems and services for shopping personalization platform 204, such as the personalization platform 140. As such, merchant 202 may provide data associated with users during their shopping experiences and flows with merchant 202 to the service provider so that the service provider may personalize the shopping experience for the user based on the privacy controls and permissions of the user.

Merchant 202 may provide behavior data, user identity signals or other identification information, and a shopping context or other information of the shopping experience of the user (e.g., items being browsed or searched, merchants searched or of interest, brands and/or item types, etc.). The personalization platform may interact with an identity platform to score an identity of the user, such as the likelihood that the identity signals originate from or indicate the presence of the user, and as such, the user is engaged in the shopping experience. Once the identity of the user is determined, a data allowance manager (DAM) 206 may be queried for a user consent to access a shopper profile 208 of the user. If authorized, shopper profile 208 may be accessed and profile data, such as user preferences, a “consumer DNA” (e.g., unique identifying characteristics and features that uniquely identify the user and make up the user’s online present, profile, or account, and the like may be provided to the personalization platform. For recommendation personalization, a product catalog or other information of the available products may be accessible so that products matching interests of a user may be determined in real-time or near-real time and based on the current product availability, descriptions, and the like.

In FIG. 2B, the system environment of FIG. 2A is shown in further detail including the user that may be browsing items and/or engaged in a shopping experience, as well as the AI platform for the personalization platform that may include multiple different models intelligently selected based on availability of feature data for model features. The system environment in FIG. 2B includes a personalization platform including an AI system and/or models that may be used for product recommendations and other inferencing, a DAM 206 or other access and authorization system that includes or is associated with an identity determination and/or verification system, a profile manager for user profiles, merchant 202 and/or a digital platform of merchant 202, and a user and/or user’s client device. Interactions between these devices, servers, and other components are shown in FIG. 2B for user-specific recommendations and other personalization based on privacy controls and AI model selection.

In this regard, a user may be provided with granular privacy controls for their profile, as well as an opt-in, permission, or the like for use of the profile for personalization and/or recommendations (which may be general for all situations of the user or specific to certain situations, contexts, domains, interactions, merchants, etc.). When a user makes a change to their profile (including preferences regarding how data for past or current transactions is used), an event may be sent to an NRT stream, which then updates the NRT features with respect to those changes. The granular settings around the user’s data allow for changes to privacy to occur in near real time.

At step 1.0, when a user accesses a shopping platform or other digital platform of merchant 202 where the user may shop for items, the merchant’s platform and/or components may detect identity signals, which may be used to identify the user and determine a likelihood of the user using one or more AI models for probabilistic user identification and determination. For example, when a shopper comes to a merchant site, the service provider may not know who the user is or have identified the user. Merchant 202 may be able to glean certain signals and information by soliciting and/or detecting the signal from the user’s device or through a persistent session on the side of the user’s device (e.g., email, phone, etc.). With a probabilistic model, the signals may be used to recognize a user. Merchant 202 may integrate with a device fingerprinting software development kit (SDK), which provides the service provider with a hash of device parameters and information corresponding to the device fingerprint and/or fingerprinting technique, which may be used to probabilistically identify the user. When the confidence is above a threshold, the service provider may then begin to offer more personalized recommendations, and if an account with the service provider is linked, fully customized results.

At step 2.0, API requests are handled by the personalization platform, such as those that may be received and/or exchanged with APIs of the merchant’s platform after API and/or SDK integrations and uses. The personalization platform’s API(s) may receive a request for recommendations with the shopping context, and may then route the data through the business logic to confirm consent, pull profile data for shopper profile 208, and transform recommendations. At step 3.0, product recommendations 220 are generated by accessing shopper profile 208, requesting data, and running ML models selected based on the available data. The ML models may be run using features extracted from the data and/or pulled from a cache or store, which may then return recommendations for products in a product catalog. At step 4.0, behavior data 222 is processed from events and other activities that the user may engage in with regard to the merchant, the shopping experience, and/or the recommendation.

For ML features, the feature data may be stored in an online environment and/or cache that may be made available for recommendations in real-time in the online and/or live computing environment. For example, a user may be shopping at multiple merchants using shopping personalization provided by the service provider. As such, when the user is identified with each of these sessions, the service provider may compute ML features based on this cross-merchant recognition. This may occur substantially with step 5.0, where NRT features 224 are generated. With NRT features 224, data is pulled from or provided by NRT streams and queues, such as those associated with monitoring and/or tracking user activities and other behaviors. This data may be transformed for ML features to ML feature data, which may include features across different dimensions including merchant, user, session, cohort, etc. NRT features 224 may be stored in a feature store for use by the inference system for product recommendations.

At step 6.0, features are computed in a similar manner to step 5.0. However, in step 6.0, the features are precomputed and/or brought into an offline environment. For example, data from a data lake where incoming data from NRT streams and queues is held and/or stored may be accessed and used to compute features at a regular batch interval. The event streams may be partitioned into groups based on the user, allowing correlation of activities across merchant sites to better understand what a shopper is looking for and how active they are shopping. The features may be stored both in an online feature store for inferences, but also in an offline feature store for training models. The feature stores may be different due to the different latency requirements and network fabric or makeup for feature access and use. At step 7.0, models 226 are trained in this offline environment and using the offline features. Models 226 may then be pushed to a model registry, where, when models 226 are run and/or trained, an AI system may pull updated feature values from the online feature store for models 226.

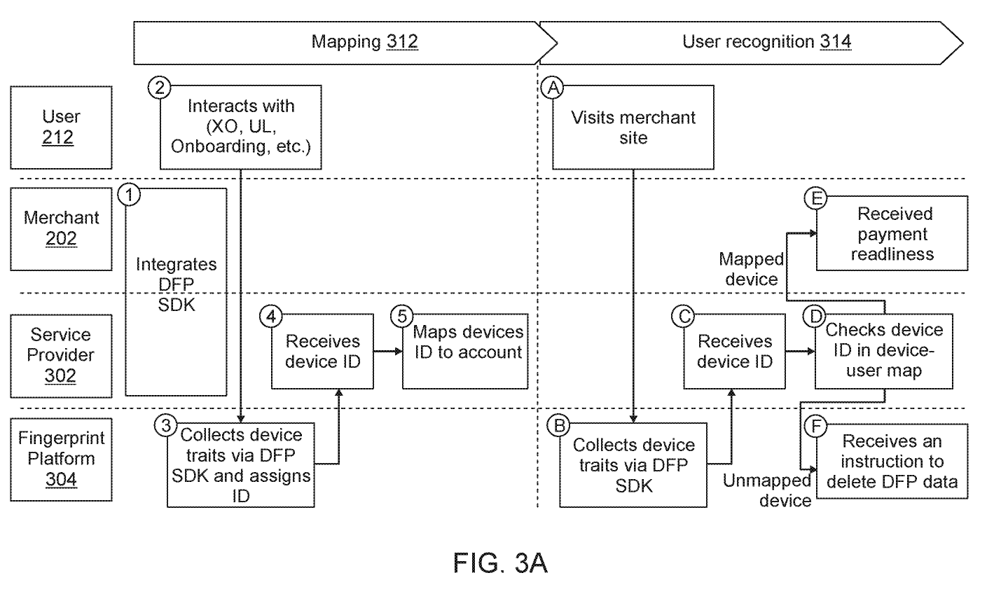

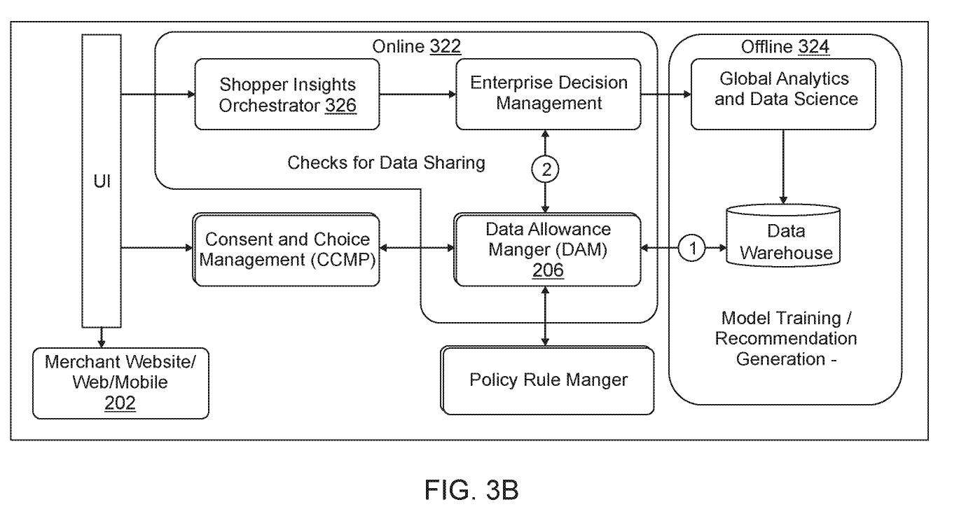

FIG. 3A and 3B are exemplary environments showing interactions between system components of a service provider when providing personalized recommendations from intelligent AI model selection, according to an embodiment. Interactions in FIG. 3A show processes by which user 212 may be detected as interacting with merchant 202 and therefore may be probabilistically identified for profile authorization and access. In this regard, during a mapping phase 312 and at step 1, initially merchant 202 may integrate with a service provider 302 to receive access to and utilize the computing services of the service provider, such as user identity, account, and/or shopping personalization. Thereafter, at step 2, user 212 may interact with service provider 302 to perform onboarding or other activity through a trusted and/or known device. This may be used to provide information for and/or establish a device fingerprint, which may be used to identify the user absent the user providing input and/or identification information during interactions with merchants.

At step 3, a fingerprint platform 304 may collect device traits and may assign the device an identifier by fingerprinting the device through a fingerprinting computation process. At step 4, the device identifier is received by the service provider, and, at step 5, the device identifier is then mapped to the user’s account. This allows for the device identifier to be used for account identification. Thereafter, during a user recognition phase, at step A, the user may visit a merchant site. Fingerprint platform 304 may collect the device traits, parameters, and other information, at step B. Fingerprint platform 304 may fingerprint the device or may provide information necessary to fingerprint the device to the service provider. At step C, the service provider receives the device fingerprint, the identifier, and/or these collected signals for the traits, parameters, and other information, and may utilize the received information to determine an account or user identity, at step D. In this regard, the device ID may be checked against a device-user mapping, and the mapped device and user may be identified. At step E, the merchant may then receive a readiness identification for the user, such as a payment readiness or other indication that the user has been identified, and at step F, instructions to delete the tracked signals of the user’s device used for fingerprinting and/or user identification may be sent to fingerprint platform 304.

In FIG. 3B, interactions are shown between a merchant website for merchant 202, a user interface (UI) of a service provider that provides shopping personalization, an online computing environment 322, and an offline computing environment 324. In this regard, a merchant website for merchant 202 may be provided through a web browser, mobile application, or the like, and the UI may allow for interfacing with the internal components of the service provider for shopping recommendations. Online computing environment 322 of the shopping personalization platform may be used to provide or access a shopper insights orchestrator 326 and an enterprise decision management module or component, which may be used to provide recommendations and other personalization based on user opt-ins/opt-outs and privacy settings. Those privacy controls may be implemented using a consent and choice management platform for configuring consents and privacy controls, as well as DAM 206 for access control and allowance to data. A policy rule manager may be used to implement and enforce policy rules on data privacy. In offline computing environment 324, global analytics may be used to track online environment activities, such as recommendations and personalization, where a database storage system, such as big query, may be used to store data from the online environment including NRT features and other data for model training. As such, global analytics may also include a data science component for model training and/or retraining of ML models using data from the database storage system.

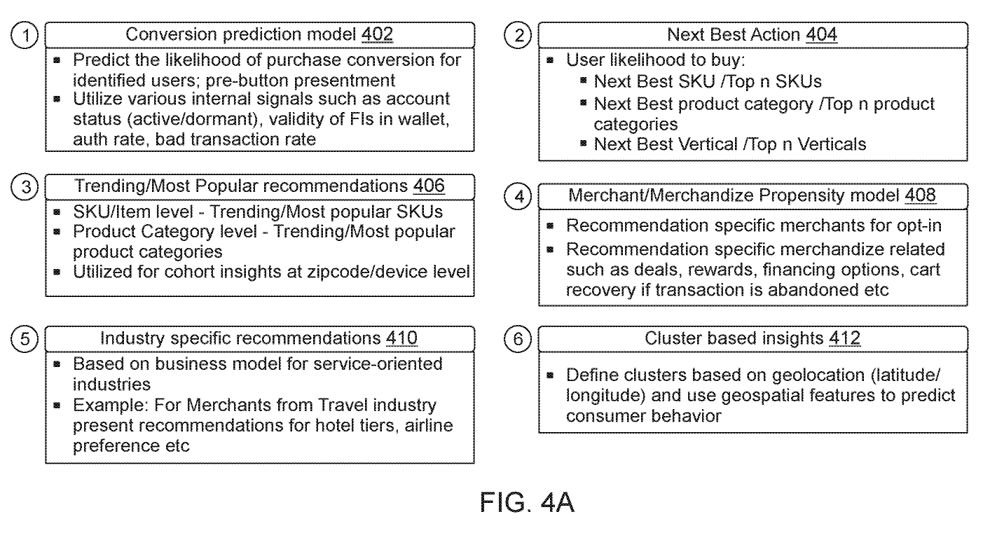

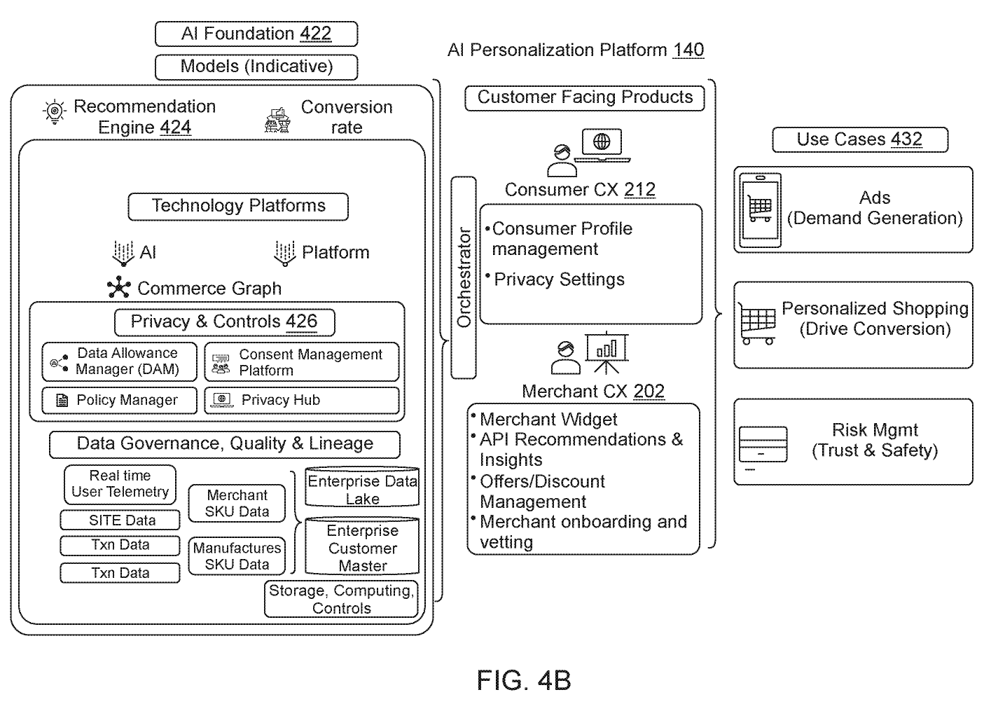

FIGS. 4A and 4B are exemplary diagrams of AI models and AI personalization for user-specific recommendations using a personalization platform, according to an embodiment. FIG. 4A shows different ML models that may be used when providing personalized recommendations to users, such as a conversion prediction model 402, a next best action model 404, a trending/most popular recommendations model 406, a merchant/merchandise propensity model 408, an industry specific recommendation model 410, and/or a cluster-based insights model 412. Each model may have corresponding benefits and/or recommendation targets, categories, or types, and each model may require different ML features and/or corresponding feature data to predict or infer a recommendation or other output for a user and/or session.

Selection of and/or use of a model may depend on the data provided or available for shopper personalization, such as whether the user has permitted access to their profile and/or the granular profile permissions to adding, storing, or tracking data. In addition, other models may also be utilized, including a geo-based trends model, an identity score model and/or service, a general recommendation model for generalized recommendations that are not user specific or are based on general user information (e.g., demographics, without knowledge of the user’s specific age, etc.), and the like. An LLM or other inferencing and generative AI with language capabilities may also be used, as well as a specific product recommendation model, a stock keeping unit (SKU) quality and/or scoring model, a catalog normalization model, a product summarization model, a speech-to-text model, and/or payment recognition or product purchase identification model.

These models may be implemented in the diagram shown in FIG. 4B. In FIG. 4B, an AI foundation 422 is shown where models are utilized with a recommendation engine 424 to provide capabilities and content for shopping personalization. Technology platforms may allow for model deployment in different environments, and privacy controls 426 may allow for enforcement of and adherence to the requirements of data governance, quality, and/or lineage. As such, an orchestrator may be used to interface these components of an AI system implementing the AI platform for customer-facing products, such as customer experiences of user 212 and/or merchant experiences of merchant 202. This may have broad applicability in different use cases 432, such as advertisements, personalized shopping, risk management, and the like.

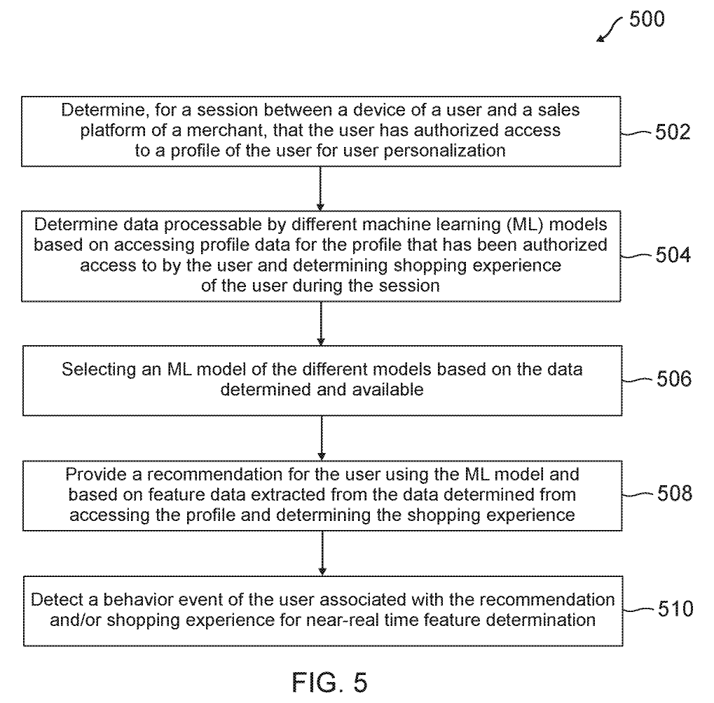

FIG. 5 is a flowchart 500 for a personalization platform for user-specific recommendations using AI model selection from user privacy controls, according to an embodiment. Note that one or more steps, processes, and methods described herein of flowchart 500 may be omitted, performed in a different sequence, or combined as desired or appropriate.

At step 502 of flowchart 500, for a session between a device of a user and a sales platform of a merchant, it is determined that the user has authorized access to a profile of the user for user personalization. When a user interacts with a merchant’s digital platform through a device, different identity signals and information may be detected. These signals may be used to determine an identity of the user, such as using an identity platform and ML model, and the user may provide or have provided an authorization to access and/or use a profile of the user for personalization with their identity, account, or the like. The profile may have granular profile controls for entry or access of personal or financial information, opting in or opting out of tracking of user data and activities, and other controls that designate what data may be stored, accessed, used, and/or associated with the profile. Additional opt-in/opt-out of profile sharing and/or use for personalization and recommendations may also be set by a user, which may be checked and used to determine that the user has authorized access to the profile, including specific data in the profile for an authorized use.

At step 504, data processable by different machine learning (ML) models is determined based on accessing profile data for the profile that has been authorized access by the user to the service provider or other entity and determining shopping experience of the user during the session. The profile data may be processed, and ML feature data may be determined and/or extracted. Along with the session information and/or shopping experience information, available feature data for ML features may be determined. This data may be combined and/or processed to determine feature data usable by one or more ML models for inferencing and recommending other products or other information to users.

At step 506, an ML model of the different models is selected based on the data determined and available. In other embodiments, more than one ML model may be selected to work in conjunction with other selected model(s). After determination of feature data, an ML model that utilizes such features may be identified, which may correspond to an ML model that may provide a most accurate or user-specific recommendation or other output. As such, depending on the user’s permission to access the profile, as well as the granular privacy controls with the profile, the user may control the specificity of recommendations and other personalization by the personalization platform, for example, by controlling which ML or other AI model may be selected for inferencing and recommendation generating. An inferencing engine may have access to a feature store, such as a database of ML features computed and/or transformed from data for different users’ sessions, their profiles, and/or behavior events and other NRT activities.

When inferencing is required for customer personalization and product recommendation, the inferencing engine may determine the available data, and therefore the ML features that may be computed or determined for ML inferencing, for the session and/or user. These may be used to identify one or more ML models from a plurality of different models available to the inferencing engine. Those models may include any of a conversion prediction model, a next best action model, a trending/most popular recommendations model, a merchant/merchandise propensity model, an industry specific recommendation model, a cluster-based insights model, a geo-based trends model, an identity scoring model, a general product or information recommendation (i.e., a non-user-specific, such as recommendation that does not consider or rely on, or is not based on, a profile for a user) model, an LLM or other generative AI with language capabilities, a product-specific recommendation model, an SKU quality and/or scoring model, a catalog normalization model, a product summarization model, a speech-to-text model, and/or payment recognition or product purchase identification model. Note that the list of models is not exhaustive and more or less models may be part of the available ML models available to be selected for the user personalization.

At step 508, a recommendation for the user is provided using the ML model and based on feature data extracted from the data determined from accessing the profile and determining the shopping experience. The ML model selected from the different available models may then be used to generate an output, such as a score or other inference, prediction, or classification associated with a product that may be recommended to the user. The recommendation may correspond to a likelihood that the user would be interested in the product based on their past experience and/or profile data, as well as the current shopping context of the user’s experience with the merchant.

At step 510, a behavior event of the user associated with the recommendation and/or shopping experience for near-real time feature determination is detected. After providing the recommendation to the user, additional activities and behaviors of the user may be tracked. Those may be associated with the recommendation, as well as other behaviors associated with the merchant, shopping experience, and the like. The behaviors may be converted and/or transformed into NRT features, and the NRT features may be used for changing, updating, or providing new recommendations in real-time or near-real time based on the user’s behaviors and activities occurring in real-time with the merchant. Additionally, the NRT features may be used in an offline environment for ML model training.

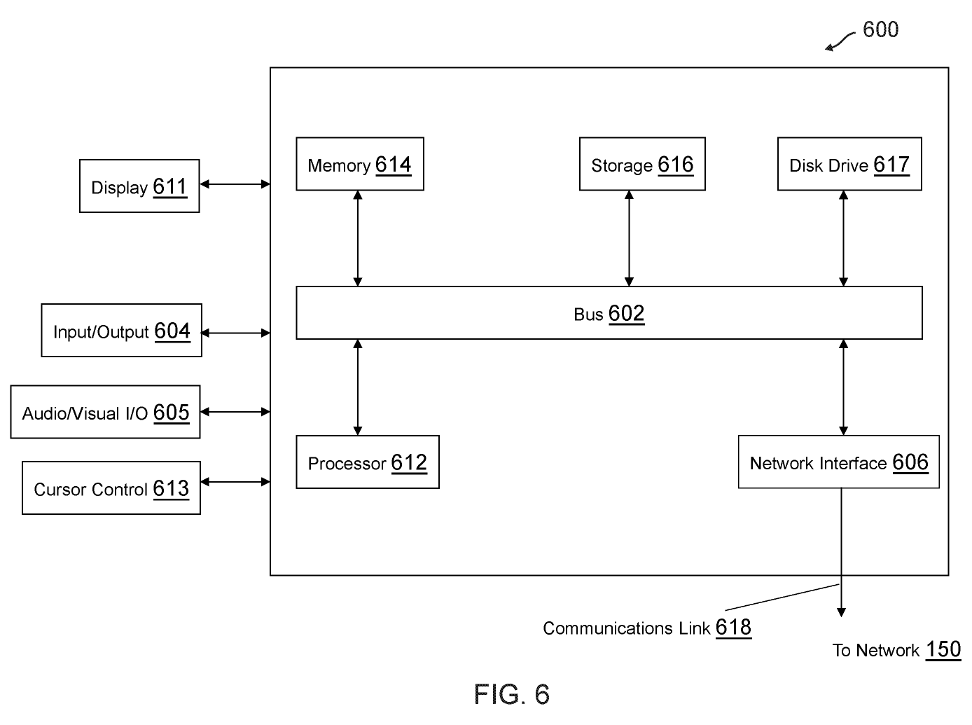

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, images, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output (I/O) component 605 may also be included to allow a user to use voice for inputting information by converting audio signals and/or input or record images/videos by capturing visual data of scenes having objects. Audio/visual I/O component 605 may allow the user to hear audio and view images/video including projections of such images/video. A transceiver or network interface 606 transmits and receives signals between computer system 600 and other devices, such as another communication device, service device, or a service provider server via network 150. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618 and network 150. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. For example, while the description focuses on gift cards, other types of funding sources that can be used to fund a transaction and provide additional value for their purchase are also within the scope of various embodiments of the invention. Thus, the present disclosure is limited only by the claims.

What is claimed is:

1. A method comprising:
detecting a session between a computing device of a user and a digital shopping platform associated with a merchant, wherein the session is associated with a shopping experience of the user with the merchant;
determining an authorization for accessing a profile of the user based on a privacy control of the user and a privacy management platform associated with managing access to the profile;
accessing profile data for the profile based on the authorization;
selecting a first machine learning (ML) model configured for first recommendations from a plurality of ML models based on the profile data and ML features of the plurality of ML models;
generating a recommendation for the user using the first ML model and based on ML feature data associated with at least one of the profile data or the shopping experience;
detecting a behavior event of the user that is associated with at least one of the recommendation or the shopping experience;
determining additional ML feature data associated with the shopping experience based on processing the behavior event; and
storing the additional ML feature data that enables one or more additional recommendations to be determined by the first ML model for the user.

2. The method of claim 1, wherein the determining the additional ML feature data comprises:
pulling data from at least one of a data stream or a data queue for the behavior event detected;
deduplicating matching events from the data stream and the data queue in the data; and
generating near-real time (NRT) features from the data, wherein the additional ML feature data include the NRT features.

3. The method of claim 1, further comprising:
computing, in an offline environment, updated ML feature data for the ML feature data; and
storing the updated ML feature data with an online feature store and an offline model updater.

4. The method of claim 3, further comprising:
training, in the offline environment, at least one of the first ML model or a second ML model of the plurality of ML models using the offline model updater and based on the updated ML feature data.

5. The method of claim 4, further comprising:
pushing the at least one of the first ML model or the second ML model to an online environment utilizing the plurality of ML models.

6. The method of claim 3, further comprising:
updating at least one of the profile or feature values for the ML features based on the updated ML feature data.

7. The method of claim 1, wherein the additional ML feature data is associated with NRT features for an NRT recommendation by the first ML model during the shopping experience, and wherein, based on the behavior event indicating an interaction by the user with a product or a purchase, the method further comprises:
determining, using the first ML model, the NRT recommendation based at least on the profile data and the NRT features.

8. The method of claim 1, wherein the determining the authorization comprises:
querying the privacy management platform for the authorization;
receiving a binary permission for the authorization, wherein the binary permission comprises one of a no access permission to the profile data or a full access permission to the profile data;
determining that the binary permission comprises the full access permission; and
retrieving the profile data based on the binary permission comprising the full access permission,
and wherein the profile comprises one or more opt-in controls or one or more opt-out controls that limit at least one of user information, historical transaction information, or shopping preferences of the user from the profile data.

9. The method of claim 8, wherein the privacy management platform comprises a computing service that generates a decision on whether to allow access to the profile based on one or more user permissions of the user.

10. A system comprising:
a non-transitory memory; and
one or more hardware processors coupled to the non-transitory memory and configured to execute instructions to cause the system to:
detect a session between a computing device of a user and a digital shopping platform associated with a merchant during a digital interaction between the user and the merchant;
store first data associated with a first set of machine learning (ML) features for a plurality of ML models utilizable for a personalization of recommendations during digital interactions;
query a privacy management platform for an authorization to access a profile of the user based on a privacy control of the user for the profile;
authorize an access to the profile based on a response from the privacy management platform;
determine second data associated with a second set of ML features of one or more of the plurality of ML models based on data from the profile, wherein the second set of ML features comprise additional ML features usable by the one or more of the plurality of ML models for the personalization of the recommendations;
select a first ML model from the one or more of the plurality of ML models that utilize the second set of ML features based on at least one of the profile data or the digital interaction; and
generate a recommendation for the user using the first ML model and based on the first and second data for the first and second sets of ML features.

11. The system of claim 10, wherein executing the instructions further causes the system to:
detect a behavior event of the user that is associated with at least one of the recommendation or the digital interaction;
determine third data associated based on the behavior event; and
store the third data that enables one or more additional recommendations to be determined by the first ML model for the user.

12. The system of claim 11, wherein determining the third data comprises:
pulling data available from at least one of a data stream or a data queue for the behavior event detected;
deduplicating matching events from the data stream and the data queue in the data; and
generating near-real time (NRT) features from the pulled data, wherein the third data include the NRT features.

13. The system of claim 10, wherein executing the instructions further causes the system to:
compute, in an offline environment, updated ML feature data for the first and second data; and
store the updated ML feature data with an online feature store and an offline model updater.

14. The system of claim 13, wherein executing the instructions further causes the system to:
train, in the offline environment, at least one of the first ML model or a second ML model of the plurality of ML models using the offline model updater and based on the updated ML feature data.

15. The system of claim 14, wherein executing the instructions further causes the system to:
push the at least one of the first ML model or the second ML model to an online environment for real-time decision-making.

16. The system of claim 13, wherein executing the instructions further causes the system to:
update at least one of the profile or feature values for at least one of the first set of ML features or the second set of ML features based on the updated ML feature data.

17. The system of claim 13, wherein the updated ML feature data comprises NRT features for an NRT recommendation by the first ML model during the digital interaction.

18. The system of claim 10, wherein the privacy management platform comprises a computing service that generates a decision on whether to allow access to the profile based on one or more user permissions of the user.

19. A non-transitory machine-readable medium having instructions stored thereon, the instructions executable to cause performance of operations comprising:
detecting a session between a computing device of a user and a digital shopping platform associated with a merchant, wherein the session is associated with a shopping session of the user with the merchant;
determining an authorization for accessing a profile of the user based on a privacy control of the user and a privacy management platform that manages access to the profile;
accessing profile data for the user based on the authorization;
selecting a first machine learning (ML) model configured for first product recommendations from a plurality of ML models based on the profile data and ML features of the plurality of ML models;
generating a recommendation for the user using the first ML model and based on ML feature data associated with at least one of the profile data or the shopping session;
detecting a behavior event of the user that is associated with at least one of the recommendation or the shopping session;
determining additional ML feature data associated with the shopping session based on processing the behavior event; and
storing the additional ML feature data that enables one or more additional recommendations to be determined by the first ML model for the user

20. The non-transitory machine-readable medium of claim 19, wherein the determining the additional ML feature data comprises:
pulling data available from at least one of a data stream or a data queue for the behavior event detected;
deduplicating matching events from the data stream and the data queue in the data; and
generating near-real time (NRT) features from the data, wherein the additional ML feature data include the NRT features.
